(19) United States
(12) Patent Application Publication
(10) Pub. No.: US 2010/0001043 A1
(43) Pub. Date: Jan. 7, 2010

(54) METHOD AND STRUCTURE FOR JOINING MEMBERS

(75) Inventor: Hiroshi Fukuda, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: HINO MOTORS, LTD., Hino-shi, Tokyo (JP)

(21) Appl. No.: 12/447,919

(22) PCT Filed: Nov. 9, 2007
(86) PCT No.: PCT/JP07/01226

§ 371 Date: Apr. 30, 2009

(30) Foreign Application Priority Data
Nov. 9, 2006 (JP) 2006-303935
Jan. 24, 2007 (JP) 2007-013988

(51) Int. Cl. B23K 20/12

(52) U.S. Cl. 228/114.5; 228/2.3

(57) ABSTRACT

A method and a structure for joining members are provided which are suited for reinforcement of a shape.

An auxiliary member 7 is inserted into respective holes 9a and 9b of first and second portions 8a and 8b of a main member 6 such that tip and base ends of the auxiliary member 7 are in the holes 9b and 9a of the second and first portions 8b and 8a, respectively. A joining tool 5 is pushed, while rotated, on the tip end of the auxiliary member 7 to soften the portion of the auxiliary member and the second portion 8b of the main member 6 due to frictional heat and plastic flow. Then, the joining tool 5 is released from the main member 6 to allow the second portion 8b and the plastic flow portion of the auxiliary member 7 to solidify. Further, the joining tool 5 is pushed, while rotated, on the base end of the auxiliary member 7 to soften the portion of the auxiliary member and the first portion 8a of the main member 6 due to frictional heat and plastic flow. Then, the joining tool 5 is released from the main member 6 to allow the first portion 8a and the plastic flow portion of the auxiliary member 7 to solidfy.

### TECHNICAL FIELD

The present invention relates to a method and a structure for joining members.

### BACKGROUND ART

Friction stir welding or joining is a method for interconnecting members to be joined without fusion (see, for example, Patent Literature 1).

In the method, a workpiece comprising stacked members to be joined together is rested on a support tool or backing member. While rotated, a joining tool is pushed on the workpiece to assimilate the materials softened due to frictional heat and plastic flow together through stirring.

Then, the joining tool is released from the workpiece to allow the assimilated materials to solidify, thereby joining the members together.

The joining tool comprises a cylindrical shoulder and a short cylindrical pin coaxially contiguous with the shoulder, protruded as a tip of the tool and smaller in outer diameter than the shoulder.

A technique of integrating two hollow extruded shapes made of aluminum alloy and arranged side by side into a structure has been also proposed (see, for example, Patent Literature 2).

### [Patent Literature 1] JP 2004-136365A

### [Patent Literature 2] JP 2002-137071A

### SUMMARY OF INVENTION

### Technical Problems

A shape with cross-section constituted by two face plates interconnected through ribs exhibits more stiffness than the face plates and ribs themselves owing to their cooperation. However, in some situations, a shape with locally enhanced stiffness is requested.

In order to comply with the request, ribs between the two face plates may be increased in number. This, however, results in increase in overall weight of the shape and thus increase in cost since the ribs exist all over the length of the shape.

The invention was made in view of the above and has its object to provide a method and a structure for joining members suited for reinforcement of a shape.

### Solution to Problems

In order to attain the above object, the invention comprises forming a hole on a first portion of a main member and a hole on a second portion of the main member opposite to said first portion, said holes being oppositely to each other, inserting an auxiliary member into the holes such that tip and base ends of the auxiliary member are in the holes of the second and first portion of the main member, respectively, rotating and pushing a joining tool on the tip end of the auxiliary member to deform a material of the auxiliary member softened due to frictional heat and plastic flow and to soften a material of the second portion of the main member due to frictional heat and plastic flow for assimilation therewith, then releasing the joining tool from the main member to allow the second portion of the main member and the plastic flow portion of the auxiliary member to solidify, further rotating and pushing the joining tool on the base end of the auxiliary member to deform the material of the auxiliary member softened due to frictional heat and plastic flow and to soften the material of the first portion of the main member due to frictional heat and plastic flow for assimilation therewith, then releasing the joining tool from the main member to allow the first portion and the plastic flow portion of the auxiliary member to solidify.

The invention comprises a main member having first and second portions formed with respective holes opposite to each other and an auxiliary member with tip and base ends being in the holes of the second and first portions of the main member, respectively, the tip and base ends of the auxiliary member being assimilated with the first and second portions of said main member, respectively, due to frictional heat and plastic flow.

The invention comprises a main member having first and second portions formed with respective holes opposite to each other, an auxiliary member with tip and base ends being in the holes of the second and first portions of the main member, respectively, and a flange on the base end of the auxiliary member so as to engage with the first portion, the tip and base ends of said auxiliary member being assimilated with the first and second portions of said main member, respectively, due to frictional heat and plastic flow.

The invention comprises a main member having first and second portions formed with respectively holes opposite to each other, an auxiliary member with tip and base ends being in the holes of the second and first portions of the main member, respectively, and an additional member fitted over the base or tip end of the auxiliary member and abutting on the main member, the tip and base ends of said auxiliary member being assimilated with the first and second portions of said main member, respectively, due to frictional heat and plastic flow.

The invention comprises a main member having first and second portions formed with respective holes opposite to each other, an auxiliary member with tip and base ends being in the holes of the second and first portions of the main member, respectively, and an additional member fitted over the base or tip end of the auxiliary member and abutting on the main member, the tip and base ends of said auxiliary member being assimilated with the first and second portions of said main member, respectively, due to frictional heat and plastic flow, whereby the additional member is pinched in a direction of thickness thereof.

The invention comprises a main member having first and second portions formed with respective holes opposite to each other, an auxiliary member with tip and base ends being in the holes of the second and first portions of the main member, respectively, a first additional member fitted over the base end of said auxiliary member and abutting on the main member and a second additional member fitted over the tip end of said auxiliary member and abutting on the main member, the tip and base ends of said auxiliary member being assimilated with the first and second portions of the main member and with the first and second additional members, respectively, due to frictional heat and plastic flow.

The invention comprises a main member having first and second portions formed with respective holes opposite to each other, an auxiliary member with tip and base ends being in the holes of the second and first portions of the main member, respectively, a first additional member fitted over the base end of the auxiliary member and abutting on the main member and a second additional member fitted over the tip end of said auxiliary member and abutting on the main member, the tip and base ends of said auxiliary member being assimilated with the first and second portions of said main member, respectively, due to frictional heat and plastic flow, whereby each of the first and second additional members is pinched in a direction of thickness thereof.

### Advantageous Effects of Invention

According to a method and structure for joining members of the invention, the following excellent effects and advantages can be obtained.

(1) The base and tip ends of the auxiliary member are assimilated with the main member due to frictional heat and plastic flow, so that stiffness of the main member is locally enhanced and moreover the main member is prevented from being increased in weight.
(2) Stiffness enhancement of the main member and attachment of the additional member are concurrently completed, leading to reduction in number of procedures for assembling the members.

### BRIEF DESCRIPTION OF DRAWINGS

FIG. 1 includes schematic diagrams showing construction sequence of a first embodiment of a structure for joining members according to the invention;

FIG. 2 includes schematic diagrams showing construction sequence of a second embodiment of a structure for joining members according to the invention;

FIG. 3 includes schematic diagrams showing construction sequence of a third embodiment of a structure for joining members according to the invention;

FIG. 4 includes schematic diagrams showing construction sequence of a fourth embodiment of a structure for joining members according to the invention;

FIG. 5 is a schematic diagram showing construction sequence of a fifth embodiment of a structure for joining members according to the invention;

FIG. 6 is a schematic diagram showing construction sequence of a sixth embodiment of a structure for joining members according to the invention; and

FIG. 7 is a schematic diagram showing alternative construction sequence relevant to a structure for joining members according to the invention.

### REFERENCE SIGNS LIST

5 joining tool
6 main member
7 auxiliary member
8a first portion
8b second portion
9a hole
9b hole
10 assimilation layer
11 assimilation layer
15 flange
16 auxiliary member
17 assimilation layer
18 assimilation layer
21 additional member (first additional member)
22 assimilation layer
24 additional member (second additional member)
25 assimilation layer
27 additional member (first additional member)
28 assimilation layer
30 additional member (second additional member)
31 assimilation layer

### DESCRIPTION OF EMBODIMENTS

Embodiments of the invention will be described in conjunction with the drawings.

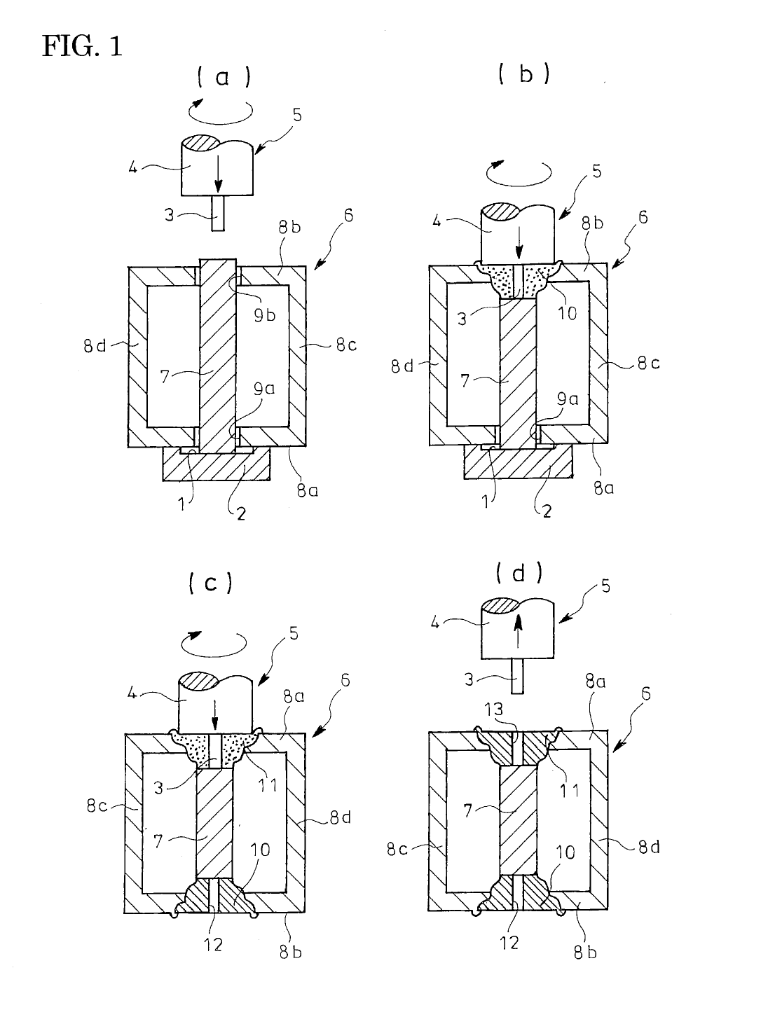

FIG. 1 is directed to a first embodiment of a structure for joining members according to the invention. Used are a backing member 2 with a recess 1 and a joining tool 5 with a short cylindrical pin 3 coaxially contiguous with a tip surface of a cylindrical shoulder 4 so as to join a round-bar-like auxiliary member 7 to a main member 6 in the form of a hollow shape with a rectangular section.

The members 6 and 7 are made of aluminum alloy, the backing member 2 and the joining tool 5 being made of steel which is harder than and higher in softening temperature than aluminum alloy.

The main member 6 having a first portion 8a and a second portion 8b opposing thereto, each of the portions 8a and 8b being formed with holes 9a and 9b, respectively, is arranged such that a base end of the auxiliary member 7 is received by the recess 1 of the backing member 2, the base and tip ends of the member 7 being in the holes 9a and 9b of the first and second portions 8a and 8b, respectively, the joining tool 5 facing the tip end of the auxiliary member 7 (see (a) of FIG. 1).

The holes 9a and 9b may be drilled round ones when the auxiliary member 7 is a round bar; when the member 7 is a square bar or a plate, the holes 9a and 9ab may be, for example, machined correspondingly.

The pin 3 pushed, while the joining tool 5 is rotated, on the tip end of the auxiliary member 7, so that the pin 3 gradually goes in the portion of the member softened due to frictional heat and plastic flow.

Soon, the end surface of the shoulder 4 of the joining tool 5 is pushed on the tip end of the auxiliary member 7 and on the second portion 8b of the main member 6, so that the second portion 8b is also softened due to frictional heat and plastic flow. As a result, an assimilation layer 10 derived from the second portion 8b of the main member 6 and from the tip end of the auxiliary member 7 is produced in a softened state around the pin 3 of the joining tool 5 (see (b) of FIG. 1).

Pushing of the pin 3 of the rotated joining tool 5 on the tip end of the round-bar-like auxiliary member 7 may initially cause axial rotation of the member 7.

Such axial rotation of the auxiliary member 7 will cease as the material is softened; alternatively, the rotation of the auxiliary member 7 may be blocked, using a clamp or other mechanical means.

Pressing force of the joining tool 5 is transmitted via the auxiliary member 7 to the backing member 2, so that no buckling deformation is caused on third and fourth portions 8c and 8d between the first and second portions 8a and 8b of the main member 6.

Then, the joining tool 5 is released from the members 6 and 7 to allow the assimilation or plastic flow layer 10 to solidify, the base end of the auxiliary member 7 being released from the backing member 2. The members 6 and 7 are turned inside out, the assimilation layer 10 being received by the backing member (not shown), the joining tool 5 facing the base end of the auxiliary member 7.

The pin 3 is pushed, while the joining tool 5 is rotated, on the base end of the auxiliary member 7, so that the pin 3 gradually goes in the portion of the member softened due to frictional heat and plastic flow.

Soon, the end surface of the shoulder 4 of the joining tool 5 is pushed on the base end of the auxiliary member 7 and on the first portion 8a of the main member 6, so that the first portion 8a is also softened due to frictional heat and plastic flow. As a result, an assimilation layer 11 derived from the first portion 8a of the main member 6 and from the base end of the auxiliary member 7 is produced in a softened state around the pin 3 of the joining tool 5 (see (c) of FIG. 1).

The tip end of the auxiliary member 7 has been assimilated with the second portion 8b of the main member 6 into the solidified assimilation layer 10, so that no rotation of the round-bar-like auxiliary member 7 is caused by pushing of the pin 3 of the rotated joining tool 5 on the base end of the auxiliary member 7.

Pressing force of the joining tool 5 is transmitted via the auxiliary member 7 to the second portion 8b, so that no buckling deformation is caused on the third and fourth portions 8c and 8d between the first and second portions 8a and 8b of the main member 6.

Then, the joining tool 5 is released from the members 6 and 7 to allow the assimilation or plastic flow layer 11 to solidify (see (d) of FIG. 1).

Thus, the tip and base ends of the auxiliary member 7 are assimilated with the second and first portions 8b and 8a of the main member 6, respectively, thus attaining locally enhanced stiffness of the main member 6.

Holes 12 and 13 of the tip and base ends of the auxiliary member 7 produced by release of the ingoing pin 3 of the joining tool 5 may be threaded for possible bolting of further members.

In the case mentioned just above, the tip end of the auxiliary member 7 is assimilated with the second portion 8b of the main member 6; and then, the base end of the auxiliary member 7 is assimilated with the first portion 8a of the main member 6. No problem is caused even if this may be reversed such that the base end of the auxiliary member 7 is assimilated with the first portion 8a of the main member 6 and then the tip end of the auxiliary member 7 is assimilated with the second portion 8b of the main member 6.

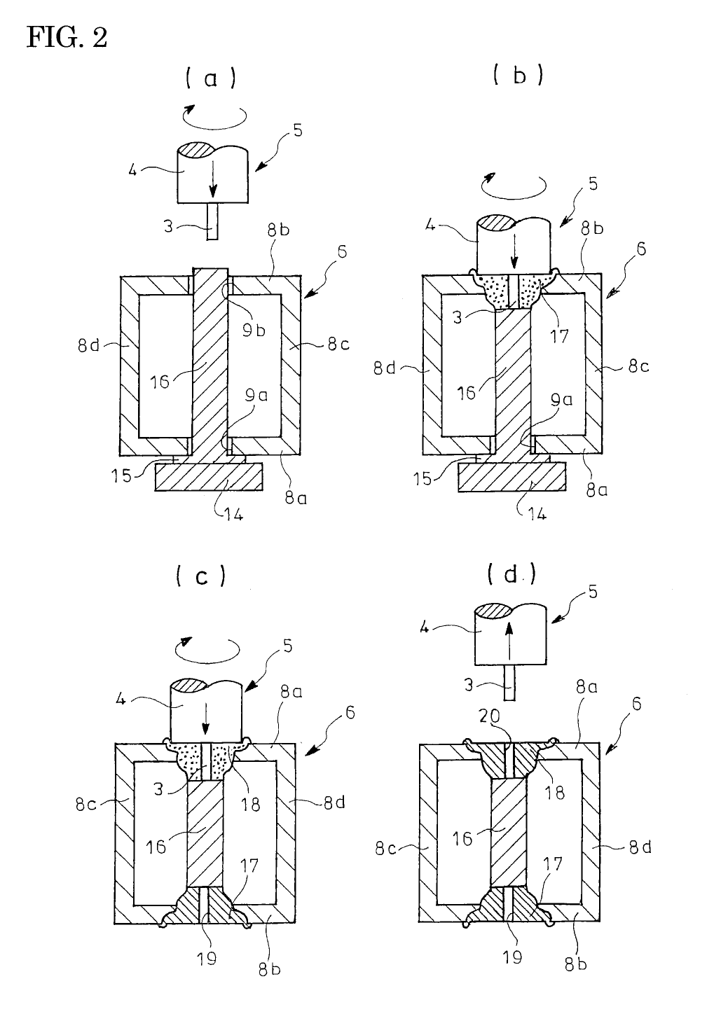

FIG. 2 is directed to a second embodiment of a structure for joining members according to the invention in which parts similar to those in FIG. 1 are represented by the same reference numerals.

In this embodiment, a flat backing member 14 and the above-mentioned joining tool 5 are used for joining, to the main member 6 in the form of a hollow shape with rectangular section, of a round-bar-like auxiliary member 16 with a base end formed with a flange 15 abutting on a first portion 8a of the main member. The auxiliary member 16 is made of aluminum alloy, the backing member 14 being made of steel which is harder than and higher in softening temperature than aluminum alloy.

The main member 6 is arranged such that the flange 15 of the auxiliary member 16 is received by the backing member 14, the base and tip ends of the auxiliary member extending through the holes 9a and 9b of the first and second portions 8a and 8b, respectively, the first portion 8a being rested on the flange 15, the joining tool 5 facing the tip end of the auxiliary member 16 (see (a) of FIG. 2).

The pin 3 is pushed, while the joining tool 5 is rotated, on the tip end of the auxiliary member 16, so that the pin 3 gradually goes in the portion of the member softened due to frictional heat and plastic flow.

Soon, the end face of the shoulder 4 of the joining tool 5 is pushed on the tip end of the auxiliary member 16 and on the second portion 8b of the main member 6, so that the second portion 8b is also softened due to frictional heat and plastic flow. As a result, an assimilation layer derived from the second portion 8b of the main member 6 and from the tip end of the auxiliary member 16 is produced in a softened state around the pin 3 of the joining tool 5 (see (b) of FIG. 2).

Pushing of the pin 3 of the rotated joining tool 5 on the tip end of the round-bar-like auxiliary member 16 may initially cause axial rotation of the auxiliary member 16.

Such axial rotation of the auxiliary member 16 will cease as the material is softened; alternatively, the rotation of the auxiliary member 16 may be blocked, using a clamp or other mechanical means.

Pressing force of the joining tool 5 is transmitted via the auxiliary member 16 to the backing member 14, so that no buckling deformation is caused on third and fourth portions 8c and 8d between the first and second portion 8a and 8b of the main member 6.

Then, the joining tool 5 is released from the members 6 and 16 to allow the assimilation or plastic flow layer 17 to solidify, the base end of the auxiliary member 16 being released from the backing member 14. The members 6 and 16 are turned inside out, the assimilation layer 17 being received by the backing member (not shown), the joining tool 5 facing the base end of the auxiliary member 16.

The pin 3 is pushed, while the joining tool 5 is rotated, on the base end of the auxiliary member 16, so that the pin 3 gradually goes in the portion of the member softened due to frictional heat and plastic flow.

Soon, the end surface of the shoulder 4 of the joining tool 5 is pushed on the flange 15 of the auxiliary member 16 and on the first portion 8a of the main member 6, so that the first portion 8a is also softened due to frictional heat and plastic flow. As a result, an assimilation layer 18 derived from the first portion 8a of the main member 6 and from the flange 15 of the auxiliary member 16 is produced in a softened state around the pin 3 of the joining tool 5 (see (c) of FIG. 2). The tip end of the auxiliary member 16 has been assimilated with the second portion 8b of the main member 6 into the solidified assimilation layer 17, so that no rotation of the round-bar-like auxiliary member 16 is caused by pushing of the pin 3 of the rotated joining tool 5 on the base end of the auxiliary member 16. Pressing force of the joining tool 5 is transmitted via the auxiliary member 16 to the second portion 8b, so that no buckling deformation is caused on the third and fourth portions 8c and 8d between the first and second portions 8a and 8b of the main member 6.

Then, the joining tool 5 is released from the members 6 and 16 to allow the assimilation or plastic flow layer to solidify (see (d) of FIG. 2).

Thus, the tip and base ends of the auxiliary member 16 are assimilated with the second and first portion 8b and 8a of the main member 6, respectively, thus attaining locally enhanced stiffness of the main member 6.

Holes 19 and 20 of the tip and base ends of the auxiliary member 16 produced by release of the ingoing pin 3 of the joining tool 5 may be threaded for possible bolting of further members.

In the case mentioned just above, the tip end of the auxiliary member 16 is assimilated with the second portion 8b of the main member 6; and then, the base end of the auxiliary member 16 is assimilated with the first portion 8a of the main member 6. No problem is caused even if this may be reversed such that the base end of the auxiliary member 16 is assimilated with the first portion 8a of the main member 6 and then the tip end of the auxiliary member 16 is assimilated with the second portion 8b of the main member 6.

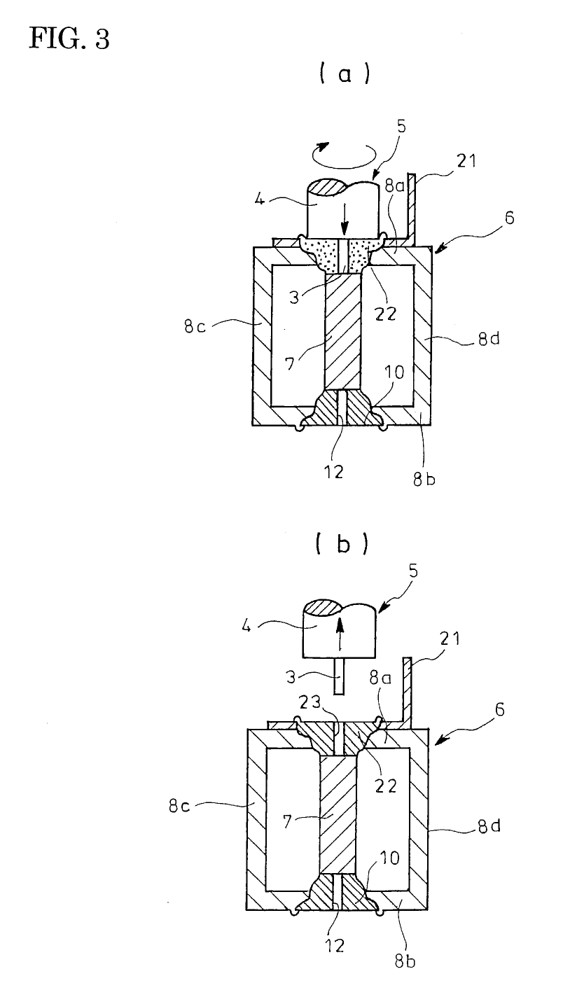

FIG. 3 is directed to a third embodiment of a structure for joining members according to the invention in which parts similar to those in FIG. 1 are represented by the same reference numerals.

In this embodiment, the assimilation layer 10 is allowed to solidify via the above-mentioned processing (b) of FIG. 1. Then, the members 6 and 7 are turned inside out, the joining tool 5 facing the base end of the auxiliary member 7, an additional member 21 being fitted over the auxiliary member 7 and rested on the first portion 8a of the main member 6.

The additional member 21 is made of aluminum alloy.

The pin 3 is pushed, while the joining tool 5 is rotated, on the base end of the auxiliary member 7, so that the pin 3 gradually goes in the portion of the member softened due to frictional heat and plastic flow.

Soon, the end surface of the shoulder 4 of the joining tool 5 is pushed on the base end of the auxiliary member 7 and on the additional member 21, so that the additional member 21 and the first portion 8a of the main member 6 are softened due to frictional heat and plastic flow. As a result, an assimilation layer 22 derived from the additional member 21, from the first portion 8a of the main member 6 and from the base end of the auxiliary member 7 is produced in a softened state around the pin 3 of the joining tool 5 (see (a) of FIG. 3).

Then, the joining tool 5 is released from the members and 7 and from the additional member 21 to allow the assimilation or plastic flow layer 22 to solidify (see (b) of FIG. 3).

Thus, the tip end of the auxiliary member 7 is assimilated with the second portion 8b the main member 6 and the base end of the auxiliary member 7 and the additional member 21 are assimilated with the first portion 8a of the main member 6, attaining locally enhanced stiffness of the main member 6 and attachment of the additional member 21 concurrently, leading to reduction in number of procedures for assembling members.

Holes 12 and 23 of the tip and base ends of the auxiliary member 7 produced by release of the ingoing pin 3 of the joining tool 5 may be threaded for possible bolting of further members.

In the case mentioned just above, the tip end of the auxiliary member 7 is assimilated with the second portion of the main member 6; and then the base end of the auxiliary member 7 is assimilated with the first portion 8a of the main member 6 and with the additional member 21. No problem is caused even if this may be reversed such that the base end of the auxiliary member 16 is assimilated with the first portion 9a of the main member 6 and with the additional member 21 and then the tip end of the auxiliary member 7 is assimilated with the second portion 8b of the main member 6.

Alternatively, the additional member 21 may be fitted over the tip end of the auxiliary member 7 to abut on the second portion 8b of the main member 6 in (a) of FIG. 1 or 2 for the purpose of assimilating the additional member with the auxiliary member 7 or 16 and with the main member 6 through the technique of friction stir joining.

Alternatively, the additional member 21 may be preliminarily fitted over the auxiliary member 16 in (a) of FIG. 2 and pinched between the first portion 8a of the main member 6 and the flange 15 of the auxiliary member 16 for the purpose of assimilating the additional member with the members 16 and 6 through the technique of friction stir joining.

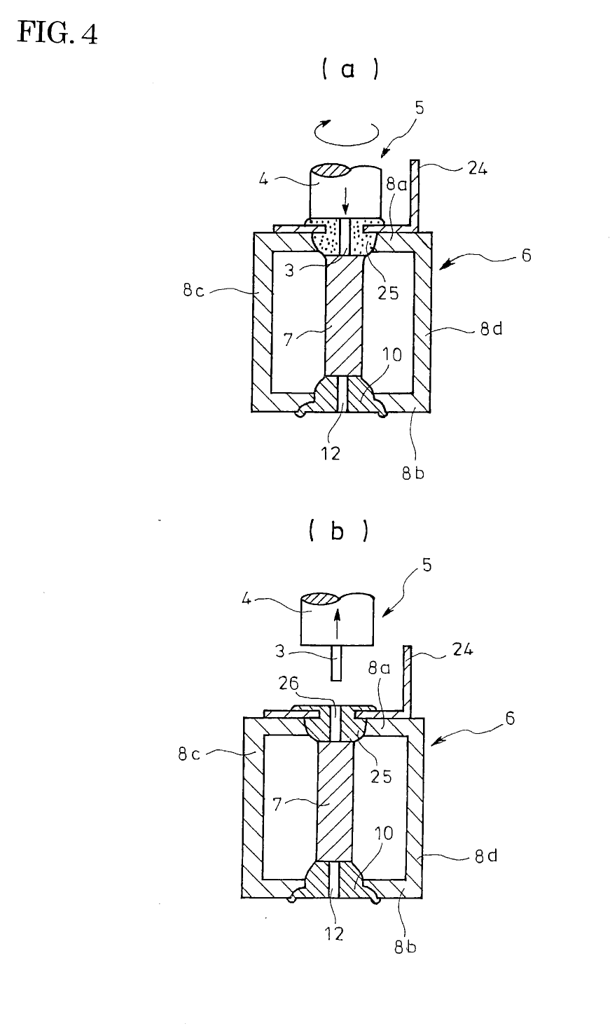

FIG. 4 is directed to a fourth embodiment of a structure for joining members according to the invention in which parts similar to those in FIG. 1 are represented by the same reference numerals.

In this embodiment, the assimilation layer 10 is allowed to solidify via the above-mentioned processing (b) of FIG. 1. Then, the members 6 and 7 are turned inside out, the joining tool 5 facing the base end of the auxiliary member 7, an additional member 24 being fitted over the auxiliary member 7 and rested on the first portion 9a of the main member 6.

The additional member 24 is made of steel.

The pin 3 is pushed, while the joining tool 5 is rotated, on the base end of the auxiliary member 7, so that the pin 3 gradually goes in the portion of the member softened due to frictional heat and plastic flow.

Soon, the end surface of the shoulder 4 of the joining tool 5 is pushed on the base end of the auxiliary member 7, so that the first portion 8a of the main member 6 is also softened due to frictional heat and plastic flow. As a result, an assimilation layer 25 derived from the first portion 8a of the main member 6 and from the base end of the auxiliary member 7 is produced in a softened state around the pin 3 of the joining tool 5 so as to pinch the additional member 24 in the direction of thickness of the member (see (a) of FIG. 4).

Then, the joining tool 5 is released from the members 6 and 7 and from the additional member 24 to allow the assimilation or plastic flow layer 25 to solidify (see (b) of FIG. 4).

Thus, tip and base ends of the auxiliary member 7 are assimilated with the second and first portions 8b and 8a of the main member 6, respectively, attaining locally enhanced stiffness of the main member 6 and attachment of the additional member 24 concurrently, leading to reduction in number of procedures for assembling the members.

Holes 12 and 26 of the tip and base ends of the auxiliary member 7 produced by release of the ingoing pin 3 of the joining tool 5 may be threaded for possible bolting of further members.

In the case mentioned just above, the tip end of the auxiliary member 7 is assimilated with the second portion 8b of the main member 6; and then, the base end of the auxiliary member 7 is assimilated with the first portion 8a of the main member 6 for assembling of the additional member 24. No problem is caused even if this may be reversed such that the base end of the auxiliary member 16 is assimilated with the first portion 8a of the main member 6 for assembling of the additional member 24 and then the tip end of the auxiliary member 7 is assimilated with the second portion 8b of the main member 6.

Alternatively, the additional member 24 may be fitted over the tip end of the auxiliary member 7 to abut on the second portion 8b of the main member 6 in (a) of FIG. 1 or 2 for the purpose of assembling the additional member to the main member 6 through the technique of friction stir joining.

Alternatively, the additional member 21 may be preliminarily fitted over the auxiliary member 16 in (a) of FIG. 2 and pinched between the first portion 8a of the main member 6 and the flange 15 of the auxiliary member 16 for the purpose of assembling the additional member to the main member 6 through the technique of friction stir joining.

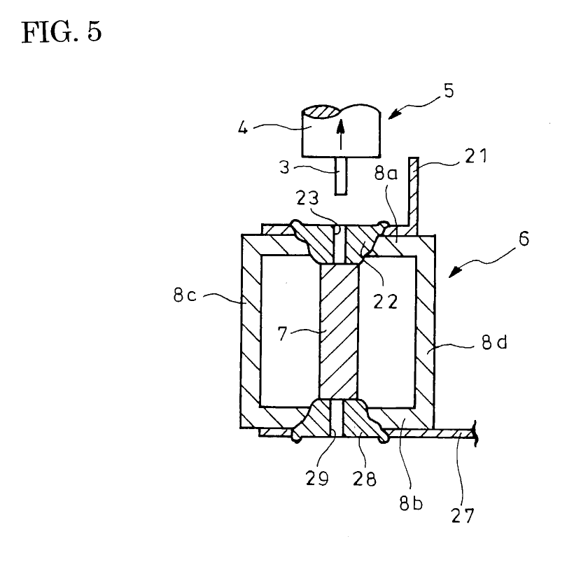

FIG. 5 is directed to a fifth embodiment of a structure for joining members according to the invention in which parts similar to those in FIG. 3 are represented by the same reference numerals.

In this embodiment, in addition to the additional member 21 fitted to the main member 6, an additional member 27 made of aluminum is fitted over the tip end of the auxiliary member 7. An assimilation layer 28 derived from the tip end of the auxiliary member 7 and from the second portion 8b of the main member 6 is formed by the joining tool 5 and then is allowed to solidify so that the additional member 27 is fitted to the members 6 and 7.

Thus, the attachment of the additional members 21 and 27 is completed concurrently with the local enhancement of the stiffness of the main member 6, leading to reduction in number of procedures for assembling the members.

Holes 29 and 23 of the tip and base ends of the auxiliary member 7 produced by release of the ingoing pin 3 of the joining tool 5 may be threaded for possible bolting of further members.

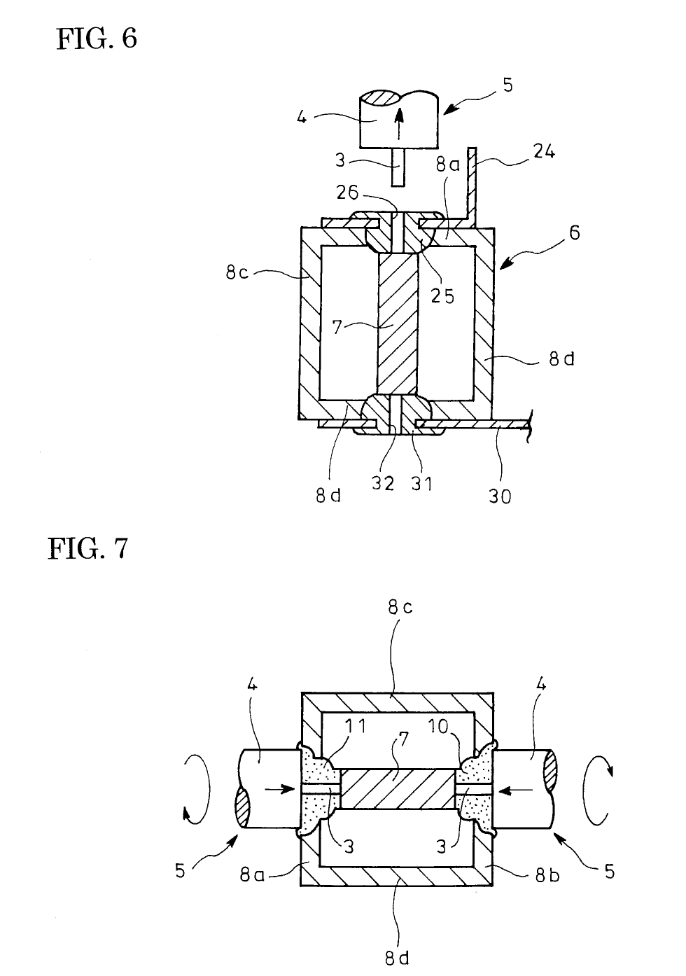

FIG. 6 shows a sixth embodiment of a structure for joining members according to the invention in which parts similar to those in FIG. 4 are represented by the same reference numerals.

In this embodiment, in addition to the additional member 24 fitted to the main member 6, an additional member 30 made of steel is fitted over the tip end of the auxiliary member 7. An assimilation layer 31 derived from the tip end of the auxiliary member 7 and from the second portion 8b of the main member 6 is formed by the joining tool 5 and then is allowed to solidify so that the additional member 30 is fitted to the members 6 and 7.

Thus, the attachment of the additional members 24 and 30 is completed concurrently with the local enhancement of the stiffness of the main member 6, leading to reduction in number of procedures for assembling the members.

Holes 32 and 26 of the tip and base ends of the auxiliary member 7 produced by release of the ingoing pin 3 of the joining tool 5 may be threaded for possible bolting of further members.

FIG. 7 is directed to alternative construction sequence relative to a structure for joining members according to the invention in which parts similar to those in FIG. 1 are represented by the same reference numerals.

In this embodiment, the pin 3 is pushed, while the joining tool 5 is rotated, on the tip end of the auxiliary member 7 to deform the material of the auxiliary member 7 softened due to frictional heat and plastic flow, and the material of the second portion 8b of the main member 6 is softened for assimilation due to frictional heat and plastic flow. In parallel with these procedures, a pin 3 is pushed, while a further joining tool 5 is rotated, on the base end of the auxiliary member 7 to deform the material of the auxiliary member 7 softened due to frictional heat and plastic flow, and the material of the first portion 8a of the main member 6 is softened for assimilation therewith due to frictional heat and plastic flow. The respective joining tools 5 are released from the members 6 and 7 to allow the assimilation or plastic flow layers 10 and 11 to solidify.

This applies not only to the structure for joining members in FIG. 1 but also to any of those in FIGS. 2-6.

It is to be understood that a method and a structure for joining members according to the invention are not limited to the above embodiment and that various changes and modifications may be made without departing from the scope of the invention. For example, a cylindrical joining tool with no pin may be used.

### INDUSTRIAL APPLICABILITY

A method and a structure for joining members according to the invention may be applied to joining and assembling of various parts or components.

1. A method for joining members characterized in that it comprises forming a hole on a first portion of a main member and a hole on a second portion of the main member opposite to said first portion, said holes being oppositely to each other, inserting an auxiliary member into the holes such that tip and base ends of the auxiliary member are in the holes of the second and first portion of the main member, respectively, rotating and pushing a joining tool on the tip end of the auxiliary member to deform a material of the auxiliary member softened due to frictional heat and plastic flow and to soften a material of the second portion of the main member due to frictional heat and plastic flow for assimilation therewith, then releasing the joining tool from the main member to allow the second portion of the main member and the plastic flow portion of the auxiliary member to solidify, further rotating and pushing the joining tool on the base end of the auxiliary member to deform the material of the auxiliary member softened due to frictional heat and plastic flow and to soften the material of the first portion of the main member due to frictional heat and plastic flow for assimilation therewith, then releasing the joining tool from the main member to allow the first portion and the plastic flow portion of the auxiliary member to solidify.

2. A structure for joining members, characterized in that it comprises a main member having first and second portions formed with respective holes opposite to each other and an auxiliary member with tip and base ends being in the holes of the second and first portions of the main member, respectively, the tip and base ends of the auxiliary member being assimilated with the first and second portions of said main member, respectively, due to frictional heat and plastic flow.

3. A structure for joining members, characterized in that it comprises a main member having first and second portions formed with respective holes opposite to each other, an auxiliary member with tip and base ends being in the holes of the second and first portions of the main member, respectively, and a flange on the base end of the auxiliary member so as to engage with the first portion, the tip and base ends of said auxiliary member being assimilated with the first and second portions of said main member, respectively, due to frictional heat and plastic flow.

4. A structure for joining members, characterized in that it comprises a main member having first and second portions formed with respectively holes opposite to each other, an auxiliary member with tip and base ends being in the holes of the second and first portions of the main member, respectively, and an additional member fitted over the base or tip end of the auxiliary member and abutting on the main member, the tip and base ends of said auxiliary member being assimilated with the first and second portions of said main member, respectively, due to frictional heat and plastic flow.

5. A structure for joining members, characterized in that it comprises a main member having first and second portions formed with respective holes opposite to each other, an auxiliary member with tip and base ends being in the holes of the second and first portions of the main member, respectively, and an additional member fitted over the base or tip end of the auxiliary member and abutting on the main member, the tip and base ends of said auxiliary member being assimilated with the first and second portions of said main member, respectively, due to frictional heat and plastic flow, whereby the additional member is pinched in a direction of thickness thereof.

6. A structure for joining members, characterized in that it comprises a main member having first and second portions formed with respective holes opposite to each other, an auxiliary member with tip and base ends being in the holes of the second and first portions of the main member, respectively, a first additional member fitted over the base end of said auxiliary member and abutting on the main member and a second additional member fitted over the tip end of said auxiliary member and abutting on the main member, the tip and base ends of said auxiliary member being assimilated with the first and second portions of the main member and with the first and second additional members, respectively, due to frictional heat and plastic flow.

7. A structure for joining members, characterized in that it comprises a main member having first and second portions formed with respective holes opposite to each other, an auxiliary member with tip and base ends being in the holes of the second and first portions of the main member, respectively, a first additional member fitted over the base end of the auxiliary member and abutting on the main member and a second additional member fitted over the tip end of said auxiliary member and abutting on the main member, the tip and base ends of said auxiliary member being assimilated with the first and second portions of said main member, respectively, due to frictional heat and plastic flow, whereby each of the first and second additional members is pinched in a direction of thickness thereof.
